(19) United States
(12) Patent Application Publication
(10) Pub. No.: US 2026/0030520 A1
(43) Pub. Date: Jan. 29, 2026

(54) TABLE METADATA INFERENCE MACHINE LEARNING MODEL

(71) Applicant: Microsoft Technology Licensing, LLC, Redmond, WA (US)

(72) Inventors: Mengyu ZHOU, Beijing (CN); Xiao LYU, Beijing (CN); Shi HAN, Beijing (CN); Dongmei ZHANG, Beijing (CN); Urmi GUPTA, Sammamish, WA (US); Bin WANG, Beijing (CN); Alfredo Ricardo ARNAIZ, Bellevue, WA (US); Ehab Sobhy DERAZ, Bellevue, WA (US); Catherine Mary PIDGEON, Bothell, WA (US)

(73) Assignee: Microsoft Technology Licensing, LLC, Redmond, WA (US)

(21) Appl. No.: 18/993,402

(22) PCT Filed: Aug. 11, 2022
(86) PCT No.: PCT/CN2022/111867

§ 371 Date: Jan. 10, 2025

(51) Int. Cl. G06N 5/022; G06F 16/26

(52) U.S. Cl. CPC G06N 5/022; G06F 16/26

(57) ABSTRACT

A computing system including memory storing a table including a plurality of entries arranged in a plurality of rows and a plurality of columns. The memory may further store a knowledge graph in which semantic data is stored. The computing system may further include a processor configured to, at a metadata inference machine learning model, generate inferred table metadata based at least in part on the entries included in the table and the semantic data included in the knowledge graph. The inferred table metadata may include one or more row type classifications of one or more respective rows or one or more column type classifications of one or more respective columns. The processor may be further configured to generate a metadata display interface element that visually represents the inferred table metadata and output the metadata display interface element for display at a graphical user interface (GUI).

### BACKGROUND

Organizations and individuals frequently perform analytics on multi-dimensional data stored in tables. The data entries stored in a table may correspond to real-world quantities, objects, processes, dimensions, or other referents. A user of a data analysis program may match the data stored in a table to its real-world referents when using the program to perform analytics tasks. Thus, the results of the data analytics may inform the user's decision-making in real-world domains.

### SUMMARY

According to one aspect of the present disclosure, a computing system is provided, including memory storing a table including a plurality of entries arranged in a plurality of rows and a plurality of columns. The memory may further store a knowledge graph in which semantic data is stored. The computing system may further include a processor configured to, at a metadata inference machine learning model, generate inferred table metadata based at least in part on the entries included in the table and the semantic data included in the knowledge graph. The inferred table metadata may include one or more row type classifications of one or more respective rows of the plurality of rows or one or more column type classifications of one or more respective columns of the plurality of columns. The processor may be further configured to generate a metadata display interface element that visually represents the inferred table metadata and output the metadata display interface element for display at a graphical user interface (GUI).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system at which inferred table metadata is computed at a metadata inference machine learning model, according to one example embodiment.

FIG. 2 schematically shows a table and a knowledge graph that may be stored in memory at the computing system of FIG. 1.

FIG. 3 schematically shows example inferred table metadata that may be computed at the metadata inference machine learning model, according to the example of FIG. 1.

FIGS. 4A-4B schematically show the architecture of the metadata inference machine learning model, according to the example of FIG. 1.

FIG. 5 schematically shows a knowledge fusion module included in the metadata inference machine learning model, according to the example of FIGS. 4A-4B.

FIG. 6 schematically shows a distribution fusion module included in the metadata inference machine learning model, according to the example of FIGS. 4A-4B.

FIG. 7A shows an example table with corresponding inferred table metadata, according to the example of FIG. 1.

FIG. 7B shows an example metadata display interface element generated from the example table of FIG. 7A based at least in part on the inferred table metadata.

FIG. 8A shows an additional example table, according to the example of FIG. 1.

FIG. 8B shows examples of metadata display interface elements generated from the example table of FIG. 8A based at least in part on the inferred table metadata.

FIG. 9A shows a flowchart of an example method for use with a computing system to generate and display inferred table metadata, according to the example of FIG. 1.

FIG. 9B shows additional steps of the method of FIG. 9A that may be performed in examples in which the metadata inference machine learning model includes a knowledge fusion module.

FIG. 9C shows additional steps of the method of FIG. 9A that may be performed in examples in which the metadata inference machine learning model includes a distribution fusion module.

FIG. 10 shows a schematic view of an example computing environment in which the computing system of FIG. 1 may be instantiated.

### DETAILED DESCRIPTION

Tabular data is organized into rows and columns. The columns in a table frequently indicate respective variables, and values of those variables are frequently stored in respective rows of the table. For example, the first row of a table may include names of the variables associated with the columns, and subsequent rows may include values of those variables at each of a plurality of sampled points. The table may accordingly include a plurality of key-value pairs as entries, with the columns indicating keys of the table and the rows indicating values associated with those keys. In many examples, the first column is a primary key including values of a variable by which the entries in the table are indexed. In such examples, the entries may be further indexed by one or more additional variables. Although the keys are typically indicated in the columns, the keys may be indicated in the rows in other examples.

Some tabular data analysis programs have capabilities by which data visualizations or insights may be programmatically generated and displayed to the user based on the data stored in a table. When generating these data visualizations or insights, a tabular data analysis program may infer the real-world referents of the data stored in the table. The referent of the data is the phenomenon described by the data, such as a location, a person, a sensor measurement, a number of objects, a time, an amount of money, a result of a computation, or any of a wide range of other phenomena for which data may be collected and stored. However, the meaning of the data may be difficult to infer programmatically. For example, when generating a data visualization, the tabular data analysis program may incorrectly determine whether to treat the data stored in a column as an independent or dependent variable. As another example, the tabular data analysis program may use an incorrect aggregation function when generating a pivot table. Such errors in data visualization and insight generation may prevent the tabular data analysis program from generating analytics that are relevant to the user.

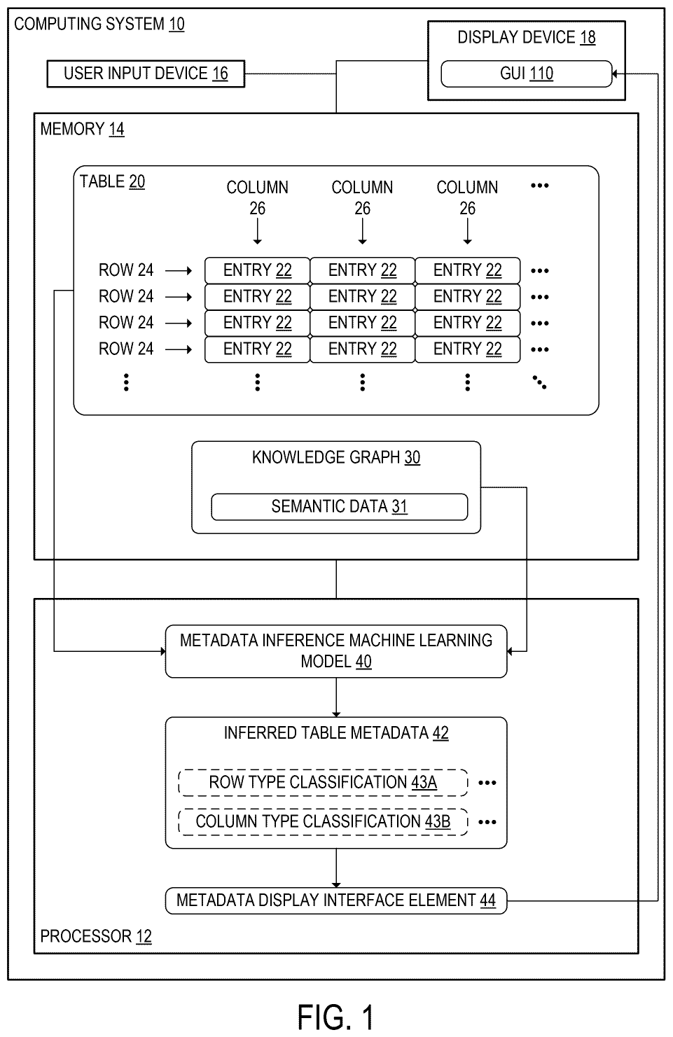

In order to address the challenges discussed above, a computing system 10 is provided, as shown in FIG. 1 according to one example embodiment. The computing system 10 includes a processor 12 configured to execute instructions to perform computing processes. The processor 12 may be instantiated in a single physical processing device or in a plurality of processing devices. For example, the processor 12 may include one or more central processing units (CPUs), graphics processing units (GPUs), field-programmable gate arrays (FPGAs), specialized hardware accelerators, and/or other types of processing devices. The computing system 10 further includes memory 14 that is communicatively coupled to the processor 12. The memory 14 may, for example, include one or more volatile memory devices and/or one or more non-volatile memory devices.

The computing system 10 of FIG. 1 further includes one or more input devices 16 via which the computing system 10 receives user input. The one or more input devices 16 may, for example, include a keyboard, a mouse, a touchscreen, a microphone, an optical sensor, and/or other types of input devices. The computing system 10 further includes one or more output devices. In the example of FIG. 1, the computing system 10 includes a display device 18. One or more other types of output devices, such as a speaker or a haptic feedback device, may additionally or alternatively be included in the computing system 10 in some examples. The display device 18 is configured to display a graphical user interface (GUI) 110 at which the user views outputs of computing processes executed at the processor 12. The user interacts with the GUI 110 via the one or more input devices 16 to provide user input to the computing system 10.

FIG. 1 shows the computing system 10 in an example in which the computing system 10 is instantiated in a single physical computing device. However, in other examples, the computing system 10 may be instantiated in a plurality of communicatively coupled physical computing devices. For example, at least a portion of the computing system 10 may be provided as a server computing device located at a data center. In such examples, the computing system 10 may further include one or more client computing devices configured to communicate with the one or more server computing devices over a network. For example, the one or more user input devices 16 and the display device 18 may be included in a client computing device, one or more computing processes may be offloaded from the client computing device to the server computing device.

The memory 14 of the computing system 10 stores a table 20 including a plurality of entries 22. The plurality of entries 22 are arranged in a plurality of rows 24 and a plurality of columns 26. Each of the entries 22 belongs to a row 24 of the plurality of rows 24 and to a column 26 of the plurality of columns 26.

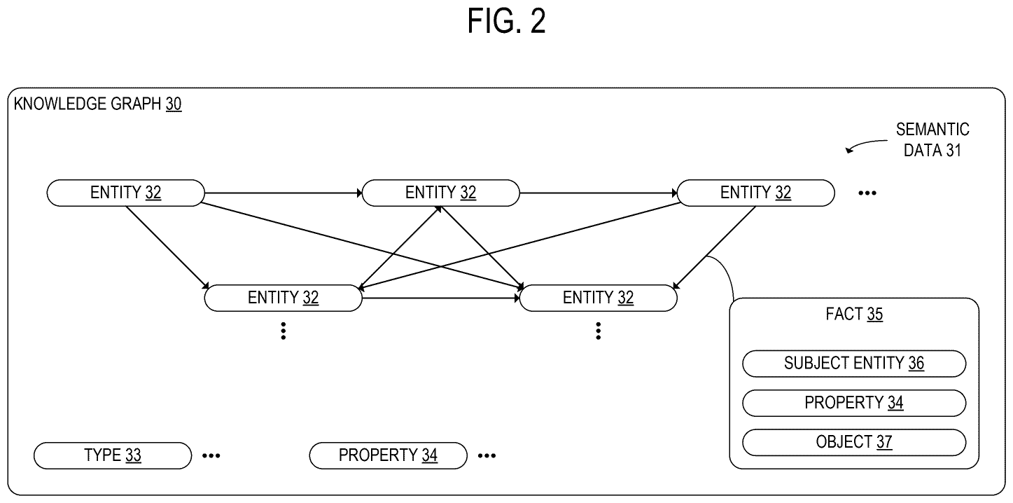

The memory 14 further stores a knowledge graph 30 in which semantic data 31 is stored. The knowledge graph 30 is shown in additional detail in the example of FIG. 2. As depicted in the example of FIG. 2, the semantic data 31 stored in the knowledge graph 30 includes a plurality of entities 32. The entities 32 have respective types 33, and the knowledge graph 30 further includes a list of the types 33 of the plurality of entities 32. The type 33 of an entity 32 may be a dimension variable type or a measure variable type. The knowledge graph 30 further includes a list of properties 34 that specify types of relationships between the entities 32. The edges of the knowledge graph 30 that connect the entities 32 are indicated as facts 35 that each include a subject entity 36, a property 34, and an object 37. Each fact 35 is a directed edge pointing from the subject entity 36 to the object 37, which may be another entity 32. Alternatively, the object 37 may be a numerical value.

Returning to the example of FIG. 1, the processor 12 is shown when a metadata inference machine learning model 40 is executed. At the metadata inference machine learning model 40, the processor 12 generates inferred table metadata 42 based at least in part on the entries 22 included in the table 20 and the semantic data 32 included in the knowledge graph 30. The inferred table metadata 42 may include a row type classification 43A of a respective row 24 of the plurality of rows 24. Additionally or alternatively, the inferred table metadata 42 may include a column type classification 43B of a respective column 26 of the plurality of columns 26. The inferred table metadata 42 may, in some examples, include a plurality of row type classifications 43A associated with a plurality of rows 24 or a plurality of column type classifications 43B associated with a plurality of columns 26. A row type classification 43A associated with a row 24 indicates a data type of the entries 22 included in that row 24. Similarly, a column type classification 43B associated with a column 26 indicates a data type of the entries 22 included in that column 26.

In some examples, as a preprocessing step to computing the inferred table metadata 42 at the metadata inference machine learning model 40, the table 20 may be converted from a row-major format or a column-major format to a relational format. In the relational format, the table 20 may be organized into a row of column headers and a plurality of rows that include the other entries 22. Thus, the metadata inference machine learning model 40 may be configured to receive both row-major tables and column-major tables as input.

The processor 12 further generates a metadata display interface element 44 that visually represents the inferred table metadata 42. In some examples, as discussed in further detail below, the metadata display interface element 44 includes a data visualization provided as a chart. Additionally or alternatively, in some examples, the metadata display interface element 44 includes a data visualization provided as a pivot table. The processor 12 further outputs the metadata display interface element 44 for display at the GUI 110. Accordingly, the metadata display interface element 44 is presented to the user.

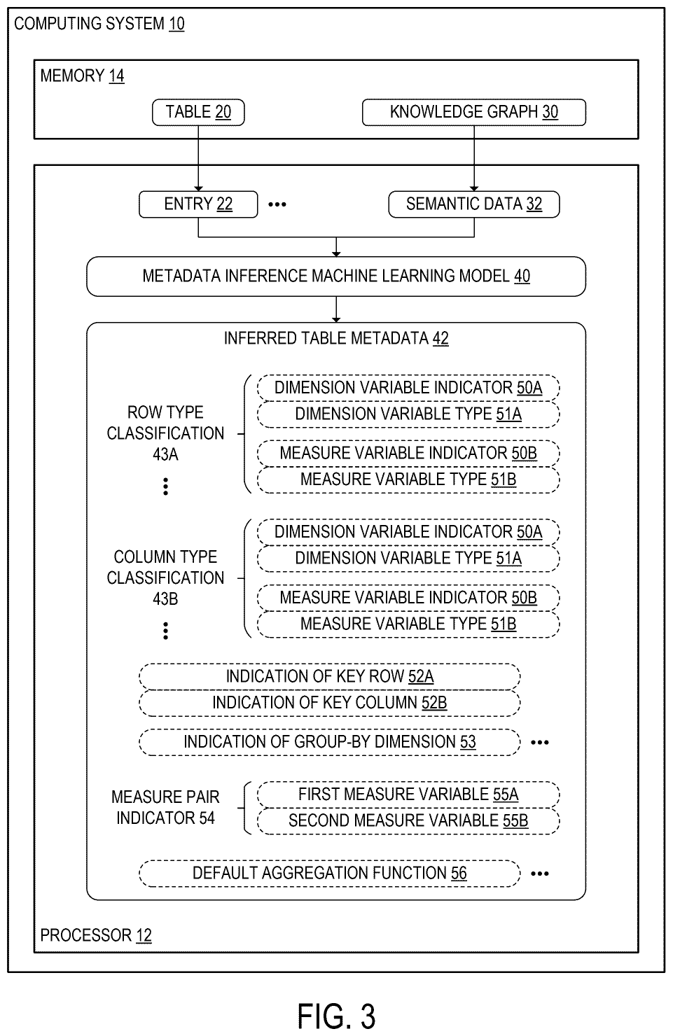

FIG. 3 shows the inferred table metadata 42 in additional detail, according to some examples. In the example of FIG. 3, a row type classification 43A and a column type classification 43B are shown, as well as additional forms of inferred table metadata 42 discussed in further detail below.

In some examples, the inferred table metadata 42 includes a dimension-versus-measure classification for a row 24 or a column 26. A dimension field in the table 20 is a field that includes categorical information. A measure field is a field that includes numerical data. Categorizing a row 24 or a column 26 as including dimension data or measure data may allow the processor 12 to determine whether the entries 22 stored in a row 24 or column 26 are suitable as inputs to categorical operations (e.g., filtering, grouping, or labeling) or as inputs to numerical computations (e.g., sum, count, average, minimum, or maximum). Thus, dimension-versus-measure classification for a row 24 or a column 26 may have the technical effect of allowing the processor 12 to select additional processing steps to perform on the entries 22 when the metadata display interface element 44 is generated.

As shown in the example of FIG. 3, when the inferred table metadata 42 includes a row type classification 43A for a row 24, the row type classification 43A includes a respective indication of whether the row 24 includes values of a dimension variable or a measure variable. Thus, the row type classification 43A includes a dimension variable indicator 50A or a measure variable indicator 50B. Similarly, when the inferred table metadata 42 includes a column type classification 43B for a column 26, the column type classification 43B includes a respective indication of whether the column 26 includes values of a dimension variable or a measure variable. Thus, the column type classification 43B includes a dimension variable indicator 50A or a measure variable indicator 50B.

The inferred table metadata 42 shown in FIG. 3 further includes a dimension variable type 51A of a dimension variable or a measure variable type 51B of a measure variable. The dimension variable type 51A or measure variable type 51B is included in the row type classification 43A or the column type classification 43B. Some example dimension variable types 51A include “people.person,” “location.location,” “organization.organization,” “sports.sports_team,” “sports.pro_athlete,” “soccer.football_team,” “time.event,” “location.country,” and “location.citytown,” among others. The above dimension variable types 51A each include a dimension type category followed by a dimension variable type 51A within that dimension category. Some example measure variable types 51B include “count (amount),” “ratio,” “angle,” “factor/coefficient,” “score,” “rank,” “monetary value,” “data/file size,” “duration,” “frequency,” “length,” “area,” “volume (capacity),” “mass (weight),” “power,” “energy,” “pressure,” “speed,” and “temperature,” among others. The measure variable types 51B are mutually exclusive in the above examples. Some of the measure variable types 51B listed above have specific units with which the measure variables are frequently indicated, whereas other measure variable types 51B are unitless quantities.

The inferred table metadata 42 shown in FIG. 3 further includes an indication of a key row 52A of the plurality of rows 24 or an indication of a key column 52B of the plurality of columns 26. The key row or key column is a row or column that includes values of a dimension variable that are unique within that row or column. Thus, in some examples, the values included in the key row or key column are used as values of a dependent variable in a chart or pivot table included in the metadata display interface element 44.

In some examples in which the inferred table metadata 42 includes an indication of a key row 52A or an indication of a key column 52B, the inferred table metadata 42 further includes an indication of a group-by dimension 53. A group-by dimension (also known as a breakdown dimension) is a dimension within which duplicated values occur. The group-by dimension is, in some examples, used to provide a secondary level of organization to the rows 24 or columns 26 in addition to that of the key row or key column. Thus, in such examples, the metadata display interface element 44 depicts the entries 22 included in the key row or the key column grouped according to the group-by dimension 53. In some examples, the table 20 has multiple group-by dimensions 53. The metadata display interface element 44 may, in such examples, show the plurality of group-by dimensions 53 with nested grouping levels.

In some examples, as shown in FIG. 3, the inferred table metadata 42 further includes a measure pair indicator 54 associated with a first measure variable 55A and a second measure variable 55B. The measure pair indicator 54 specifies a pair of measure rows or measure columns in which the entries 22 have a shared measure variable type 51B. Thus, in some examples in which the inferred table metadata 42 includes a measure pair indicator 54, the processor 12 computes an aggregation over the values of the first measure variable 55A and the second measure variable 55B and includes one or more aggregated values in the metadata display interface element 44. Additionally or alternatively, the processor 12 shows the values of the first measure variable 55A and the second measure variable 55B paired with each other (e.g., adjacent to each other in a chart or pivot table) in the metadata display interface element 44.

In some examples, the inferred table metadata 42 further includes a default aggregation function 56 associated with a measure variable. The default aggregation function 56 is a default function with which the values of the measure variable may be aggregated in a chart or pivot table included in the metadata display interface element 44. For example, the default aggregation function 56 may be Sum, Average, Max, Min, Product, StdDev, StdDevP, Var, or VarP. Other default aggregation functions 56 may be used in other examples.

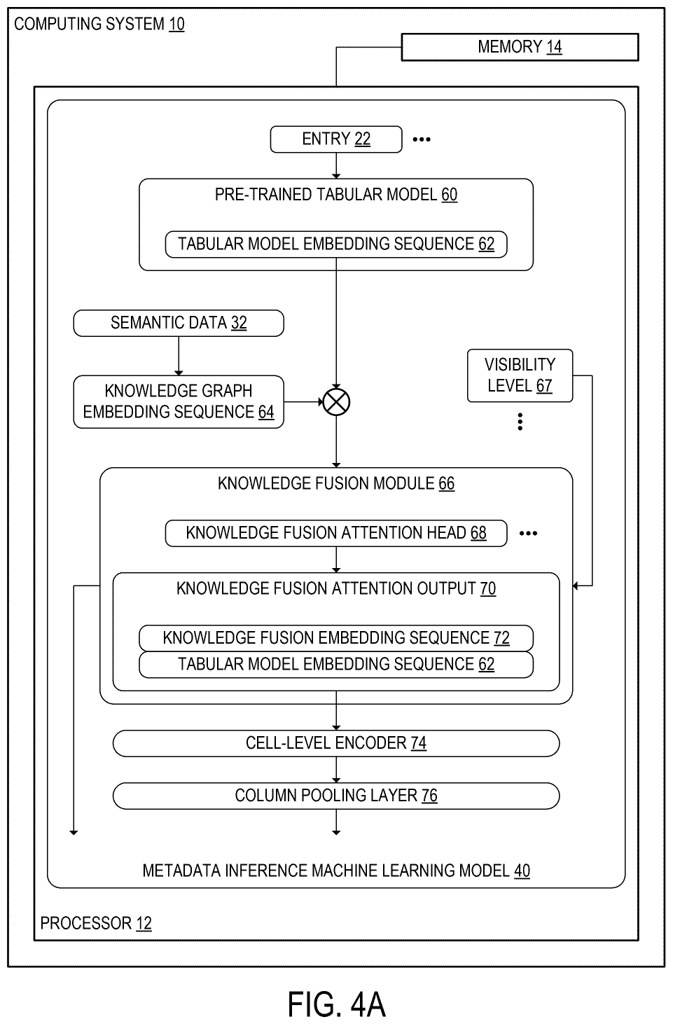

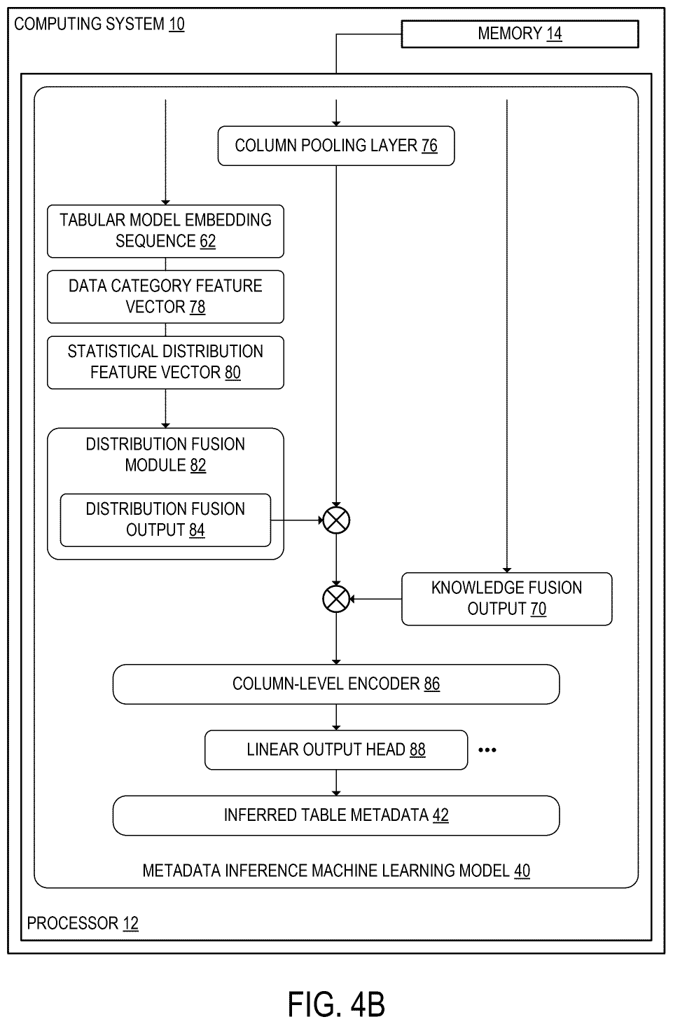

FIGS. 4A-4B schematically show the architecture of the metadata inference machine learning model 40, according to one example. As shown in FIG. 4A, the metadata inference machine learning model 40 includes a pre-trained tabular model 60. At the pre-trained tabular model 60, the processor 12 generates a tabular model embedding sequence 62 based at least in part on the plurality of entries 22. Thus, the pre-trained tabular model 60 functions as a preliminary encoder. Utilizing the pre-trained tabular model 60 may allow the metadata inference machine learning model 40 to be trained more quickly and using fewer computing resources. In some examples, the tabular model embedding sequence 62 is a sub-token-level embedding sequence. In other examples, the tabular model embedding sequence 62 is a cell-level embedding sequence. The processor 12 further inputs the tabular model embedding sequence 62 into a knowledge fusion module 66, as discussed in further detail below.

The processor 12 further computes a knowledge graph embedding sequence 64 based at least in part on the semantic data 32. The tabular model embedding sequence 62 and the knowledge graph embedding sequence 64 are both vectors of tokens that respectively represent tabular model embedding features and knowledge graph embedding features. The processor 12 may compute a product of the tabular model embedding sequence and the knowledge graph embedding sequence 64, which may be used as input at the knowledge fusion module 66. The knowledge fusion module 66 may further receive a plurality of visibility levels 67 as input, as discussed in further detail below.

As shown in the example of FIG. 4A, the knowledge fusion module 66 includes one or more knowledge fusion attention heads 68. At the one or more knowledge fusion attention heads 68 included in the knowledge fusion module 66, the processor 12 computes a knowledge fusion attention output 70 based at least in part on the tabular model embedding sequence 62 and the knowledge graph embedding sequence 64. The knowledge fusion attention output 70 may include the tabular model embedding sequence 62 along with a knowledge fusion embedding sequence 72. As discussed in further detail below, the processor 12 generates the inferred table metadata 42 based at least in part on the knowledge fusion attention output 70.

The processor 12, as shown in FIG. 4A, further transmits the knowledge fusion attention output 70 to a cell-level encoder 74 included in the metadata inference machine learning model 40. The cell-level encoder 74 may be a transformer encoder. The processor 12 may further transmit the output of the cell-level encoder 74 to a column pooling layer 76. At the column pooling layer, the processor 12 may, for example, perform average pooling to obtain respective embedding representations associated with the plurality of columns 26.

FIG. 4B shows further components that may be included in the metadata inference machine learning model 40, according to the example of FIG. 4A. As shown in FIG. 4B, the tabular model embedding sequence 62, a data category feature vector 78 that includes a plurality of data category features, and a statistical distribution feature vector 80 that includes a plurality of statistical distribution features may be received as input at a distribution fusion module 82. The processor 12 may compute the data category feature vector 78 and the statistical distribution feature vector 80 from the plurality of entries 22 included in the table 20. The data category feature vector 78 may indicate respective field categories associated with the tabular model tokens 90 included in the tabular model embedding sequence 62. Example field categories are “FieldType,” “IsPercent,” “IsCurrency,” “Has Year,” “HasMonth,” and “HasDay.” Example values of FieldType are “Unknown,” “String,” “Year,” “DateTime,” and “Decimal.” The other example field categories may be Boolean-valued. Other field categories may additionally or alternatively be used in some examples.

The statistical distribution feature vector 80 may include a plurality of statistical quantities associated with the tabular model embedding sequence 62. Example statistical quantities that may be included in the statistical distribution feature vector 80 include progression features (“ChangeRate,” “PartialOrdered,” “OrderedConfidence,” “ArithmeticProgressionConfidence,” and “GeometricProgressionConfidence”), string features (“AggrPercentFormatted,” “medianLen,” “LengthStdDev,” “AvgLogLength,” “CommonPrefix,” “CommonSuffix,” “Cardinality,” and “AbsoluteCardinality”), number range features (“Aggr01Ranged,” “Aggr0100Ranged,” “AggrInteger,” “AggrNegative,” “SumIn01,” and “SumIn0100”), and distribution features (“Benford,” “Range,” “NumRows,” “KeyEntropy,” “CharEntropy,” “Variance,” “Cov,” “Spread,” “Major,” “Skewness,” “Kurtosis,” and “Gini”). Other statistical quantities may additionally or alternatively be used in some examples.

At the distribution fusion module 82, as shown in the example of FIG. 4B, the processor 12 computes a distribution fusion output 84 based at least in part on the tabular model embedding sequence 62, the data category feature vector 78, and the statistical distribution feature vector 80. The processor 12 subsequently generates the inferred table metadata 42 based at least in part on the distribution fusion output 84. The processor 12 may compute a product of the distribution fusion output 84 with the output of the column pooling layer 76. In addition, the processor 12 may compute a product of that product with the knowledge fusion attention output 70. The resulting product may then be input into a column-level encoder 86 at which the processor 12 computes a column-level encoding. The column-level encoder 86 may be a transformer encoder.

The metadata inference machine learning model 40 may further include one or more linear output layers 88 that are configured to receive the column-level encoding and output the inferred table metadata 42. In some examples, each of the one or more linear output layers 88 may correspond to a type of inferred table metadata 42 that is output from that linear output layer 88. For example, the metadata inference machine learning model 40 may include a linear output layer 88 that outputs a dimension-versus-measure classification, a linear output layer 88 that outputs a measure variable type 51B, and a linear output layer 88 that outputs a measure pair indicator 54. Any of the types of inferred table metadata 42 shown in FIG. 3 may have corresponding linear output layers 88.

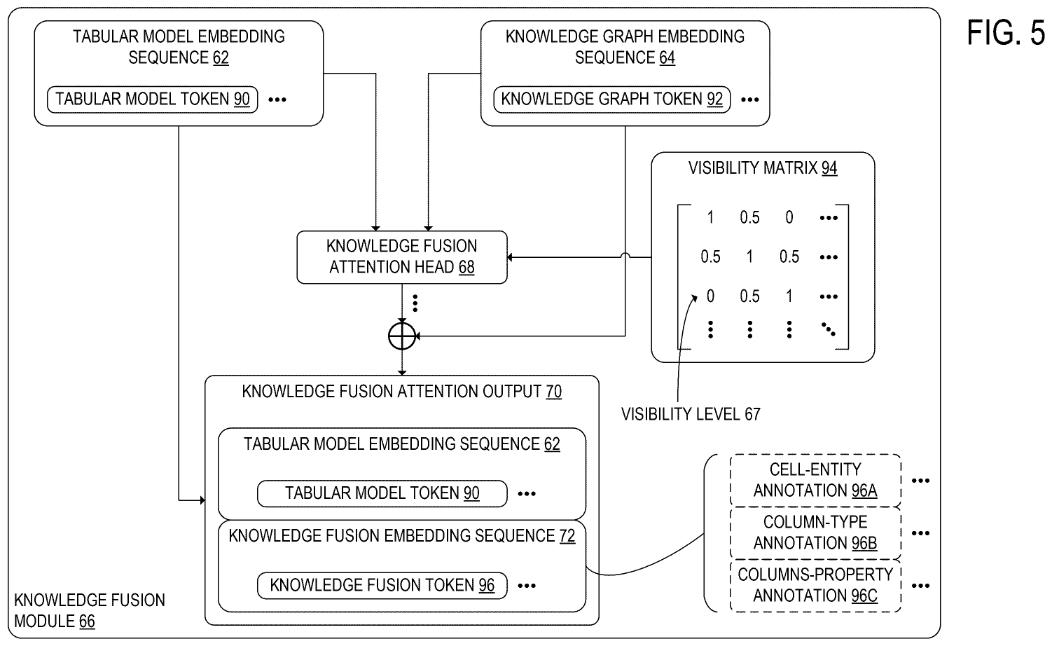

FIG. 5 shows the knowledge fusion module 66 of FIG. 4A in additional detail, according to one example. As shown in the example of FIG. 5, the tabular model embedding sequence 62 includes a plurality of tabular model tokens 90. In addition, the knowledge graph embedding sequence 64 includes a plurality of knowledge graph tokens 92.

FIG. 5 further shows the plurality of visibility levels 67 encoded in a visibility matrix 94. The visibility matrix 94 is used to perform attentional masking at the one or more knowledge fusion attention heads 68. In the example of FIG. 5, computing the knowledge fusion attention output 70 includes computing the plurality of visibility levels 67 between the plurality of tabular model tokens 90 included in the tabular model embedding sequence 62 and the respective plurality of knowledge graph tokens 92 included in the knowledge graph embedding sequence 64. The visibility levels 67 indicate coordinate overlap levels between the tabular model tokens 90 and the knowledge graph tokens 92 as specified by respective row and column coordinates of the tabular model tokens 90 and the knowledge graph tokens 92. In the example of FIG. 5, when a tabular model token 90 and a knowledge graph token 92 are associated with the same row and the same column, the visibility level 67 between the tabular model token 90 and the knowledge graph token 92 is equal to 1. When the tabular model token 90 and the knowledge graph token 92 have a shared row or a shared column but not both, the visibility level 67 between the tabular model token 90 and the knowledge graph token 92 is equal to 0.5. Some other partial visibility hyperparameter value between 0 and 1 may be used in other examples instead of 0.5. When the tabular model token 90 and the knowledge graph token 92 have neither a shared row nor a shared column, the visibility level 67 between the tabular model token 90 and the knowledge graph token 92 is equal to 0.

The processor 12 computes knowledge fusion attention at the one or more knowledge fusion attention heads 68 based at least in part on the tabular model embedding sequence 62, the knowledge graph embedding sequence 64, and the visibility matrix 94. In examples in which the one or more knowledge fusion attention heads 68 receive the visibility matrix 94, entities 32 that are likely to be of low relevance may be masked from the one or more knowledge fusion attention heads 68. The knowledge fusion attention in the example of FIG. 5 takes the form of the knowledge fusion embedding sequence 72, which includes a plurality of knowledge fusion tokens 96. The processor 12 also concatenates the tabular model embedding sequence 62 with the knowledge fusion embedding sequence 72 when computing the knowledge fusion attention output 70, such that the tabular model tokens 90 are matched to corresponding knowledge fusion tokens 96.

The knowledge fusion embedding sequence 72 may include a plurality of cell-entity annotations 96A, a plurality of column-type annotations 96B, and/or a plurality of columns-property annotations 96C among the plurality of knowledge fusion tokens 96. A cell-entity annotation 96A indicates an attention between an entry 22 of the table 20 and an entity 32 included in the knowledge graph 30. A column-type annotation 96B indicates an attention between a column 26 of the table 20 and a type 33 included in the knowledge graph 30. A columns-property annotation 96C indicates an attention between a pair of columns 26 included in the table 20 and a property 34 included in the knowledge graph 30.

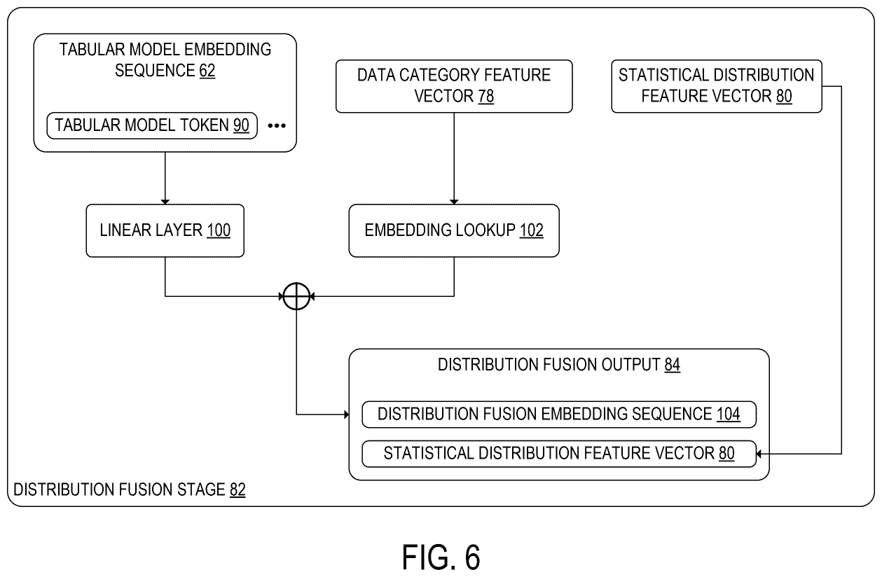

FIG. 6 shows the distribution fusion module 82 of FIG. 4B in additional detail, according to one example. At the distribution fusion module 82, the tabular model embedding sequence 62 is passed through a linear layer 100. In addition, an embedding lookup 102 is performed on the data category feature vector 78. The processor 12 concatenates the outputs of the linear layer 100 and the embedding lookup 102 to compute a distribution fusion embedding sequence 104 that is included in the distribution fusion output 84. In addition, the processor 12 includes the statistical distribution feature vector 80 in the distribution fusion output 84. In the distribution fusion output 84, elements of the statistical distribution feature vector 80 may be associated with respective elements of the distribution fusion embedding sequence 104.

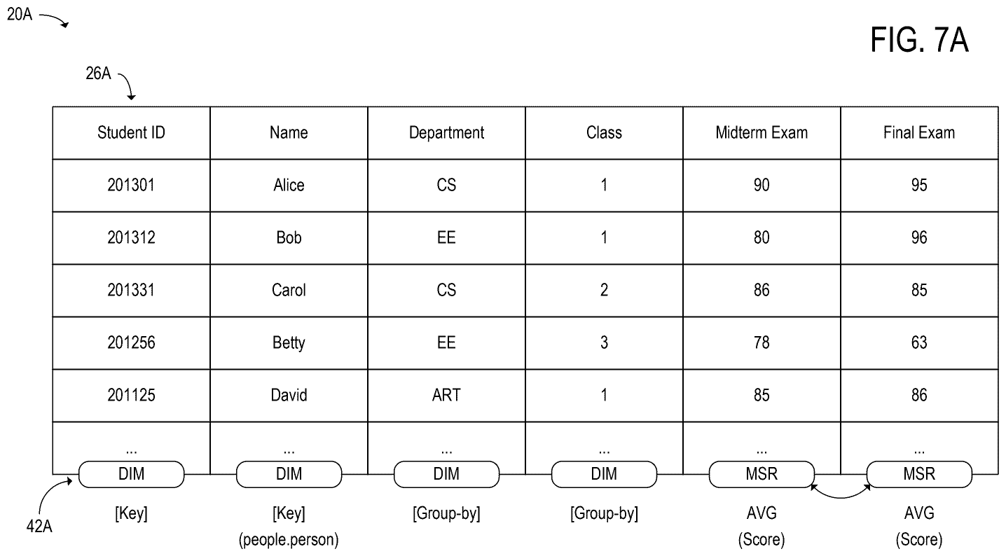

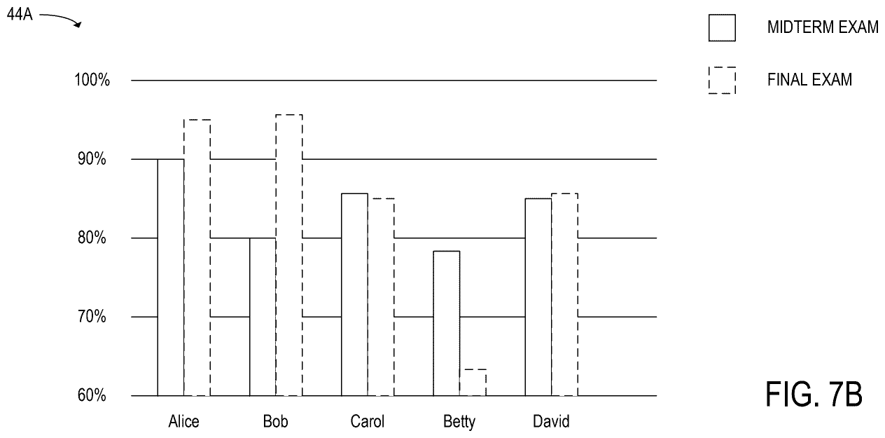

FIG. 7A shows an example table 20A along with example inferred table metadata 42A. The inferred table metadata 42A of FIG. 7A is associated with the columns 26A of the table 20A. As shown in the example of FIG. 7A, the inferred table metadata 42A includes a plurality of dimension variable indicators 50A and measure variable indicators 50B associated with the columns 26A. In addition, the inferred table metadata 42A of the “Name” column includes the dimension variable type 51A “people.person.” The inferred table metadata 42A further includes key column indications 52B indicating that the “Student ID” column and the “Name” column are potential key columns. In addition, the inferred table metadata 42A includes indications that “Department” and “Class” are potential group-by dimensions 53. The inferred table metadata further includes the measure variable type 51B “Score” associated with both the “Midterm Exam” and “Final Exam” columns. The inferred table metadata 42A also includes a measure pair indicator 54 indicating the score in the “Midterm Exam” column as the first measure variable 55A and the score in the “Final Exam” column as the second measure variable 55B.

FIG. 7B shows an example metadata display interface element 44A generated from the example table 20A and the example inferred table metadata 42A of FIG. 7A. In the example of FIG. 7B, the metadata display interface element 44A is a bar chart of midterm exam score and final exam score for each student.

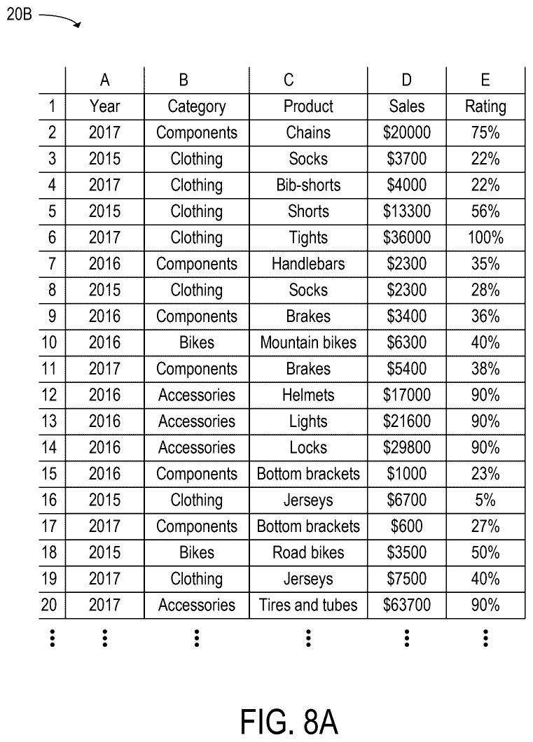

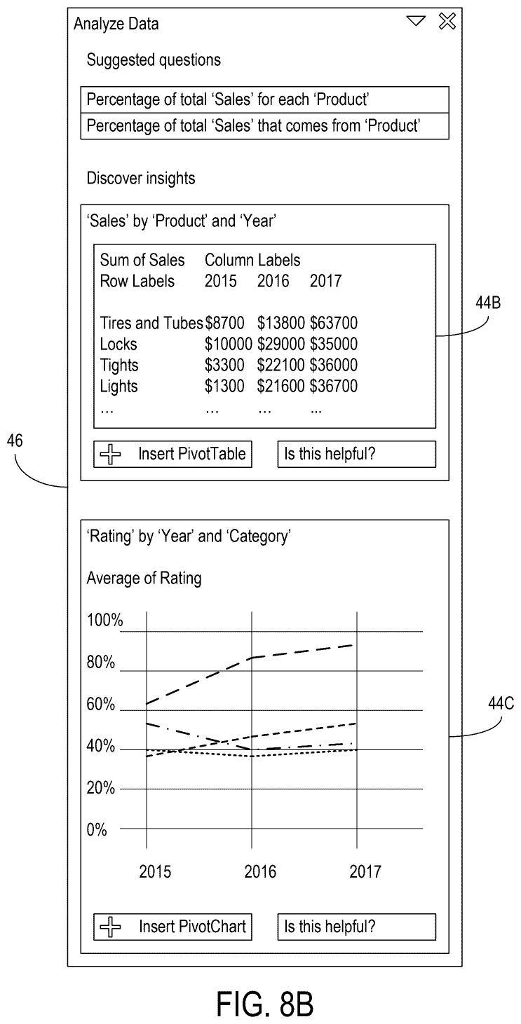

FIG. 8A shows another example table 20B. In addition, FIG. 8B shows an example metadata display interface element 44B generated for the table 20B based at least in part on inferred table metadata 42 computed for the table 20B. In the example of FIG. 8B, metadata display interface elements 44B and 44C are included in an “Analyze Data” window 46. The metadata display interface element 44B is an additional table and the metadata display interface element 44C is a chart. In the metadata display interface element 44C, average is used as a default aggregation function 56.

The “Analyze Data” window 46 depicted in FIG. 8B further includes GUI elements at which the user may provide instructions to generate an additional metadata display interface element 44. Via interaction with the GUI 110 at the “Analyze Data” window 46, the user may specify one or more variables to include in respective rows 24 and/or columns 26 of an additional metadata display interface element 44. Suggested variables to include in the additional metadata display interface element 44 are shown in the “Suggested questions” portion of the “Analyze Data” window 46.

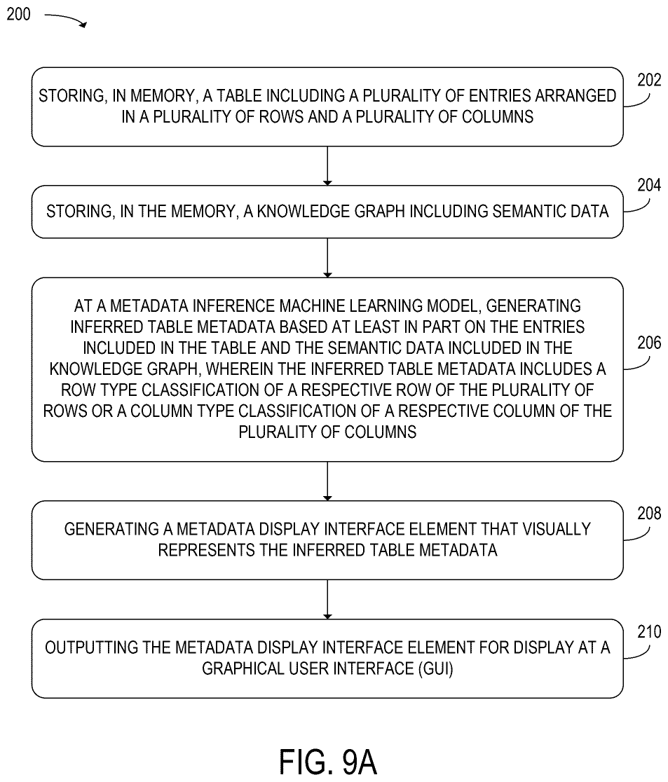

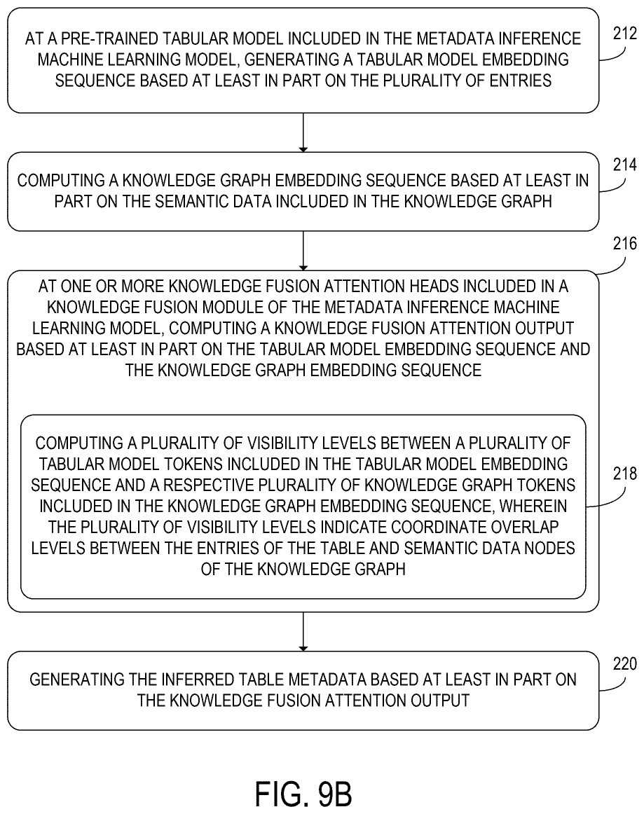

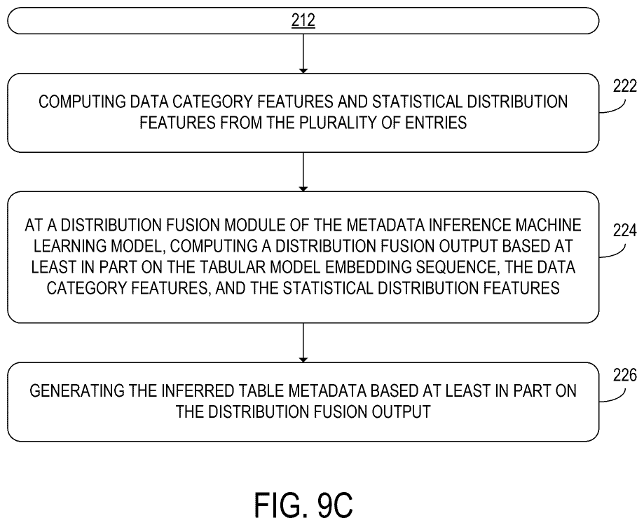

FIG. 9A shows a flowchart of a method 200 for use with a computing system to generate and display inferred table metadata. At step 202, the method 200 includes storing, in memory, a table including a plurality of entries arranged in a plurality of rows and a plurality of columns.

At step 204, the method 200 further includes storing, in the memory, a knowledge graph including semantic data. The knowledge graph may include a plurality of entities connected by a plurality of directed edges that indicate relationships between the entities. The entities may have respective types, which may be dimension variable types or measure variable types. In some examples, the knowledge graph may further include one or more relationships between entities and numerical values.

At step 206, the method 200 further includes generating inferred table metadata at a metadata inference machine learning model. The inferred table metadata is generated based at least in part on the entries included in the table and the semantic data included in the knowledge graph. The inferred table metadata includes a row type classification of a respective row of the plurality of rows or a column type classification of a respective column of the plurality of columns.

In examples in which the inferred table metadata includes a row type classification of a row, the row type classification may include a respective indication of whether the row includes values of a dimension variable or a measure variable. Additionally or alternatively, in examples in which the inferred table metadata includes a column type classification of a column, the column type classification may include a respective indication of whether the column includes values of a dimension variable or a measure variable.

The inferred table metadata may, in some examples, further include an indication of a key row of the plurality of rows or a key column of the plurality of columns and may further include an indication of a group-by dimension. In examples in which the inferred table metadata includes a key row indication or a key column indication and an indication of a group-by dimension, the metadata display interface element may depict the entries included in the key row or the key column grouped according to the group-by dimension.

In some examples, the inferred table metadata may include a dimension variable type of a dimension variable or a measure variable type of a measure variable. In such examples, the inferred table metadata may further include a measure pair indicator associated with a first measure variable and a second measure variable. The measure pair indicator may indicate that a row or column that includes values of the first measure variable has a shared measure variable type with the row or column that includes values of the second measure variable. The inferred table metadata may additionally or alternatively include a default aggregation function associated with a measure variable.

At step 208, the method 200 further includes generating a metadata display interface element that visually represents the inferred table metadata. At step 210, the method 200 further includes outputting the metadata display interface element for display at a GUI. The metadata display interface element may, for example, be a chart or a table. In examples in which the inferred table metadata includes a measure pair indicator, the values of the first measure variable and the second measure variable may be displayed concurrently in the metadata display interface element. In addition, when the inferred table metadata includes a default aggregation function for a measure variable, the metadata display interface element may show an aggregated value of that measure variable computed using the default aggregation function.

FIG. 9B shows additional steps of the method 200 that may be performed in some examples. In such examples, the method 200 further includes, at step 212, generating a tabular model embedding sequence based at least in part on the plurality of entries. The tabular model embedding sequence includes a plurality of tabular model tokens. The tabular model embedding sequence is generated at a pre-trained tabular model included in the metadata inference machine learning model. For example, the pre-trained tabular model may be a transformer encoder.

At step 214, according to the example of FIG. 9B, the method 200 further includes computing a knowledge graph embedding sequence based at least in part on the semantic data included in the knowledge graph. The knowledge graph embedding sequence includes a plurality of knowledge graph tokens.

At step 216, according to the example of FIG. 9B, the method 200 further includes computing a knowledge fusion attention output based at least in part on the tabular model embedding sequence and the knowledge graph embedding sequence. The knowledge fusion attention output is computed at one or more knowledge fusion attention heads included in a knowledge fusion module of the metadata inference machine learning model. The knowledge fusion attention output includes the tabular model embedding sequence and a knowledge fusion embedding sequence that includes a plurality of knowledge fusion tokens paired with the tabular model tokens of the tabular model embedding sequence.

At step 218, step 216 may include computing a plurality of visibility levels between the plurality of tabular model tokens included in the tabular model embedding sequence and the respective plurality of knowledge graph tokens included in the knowledge graph embedding sequence. The plurality of visibility levels may indicate coordinate overlap levels between the tabular model tokens and the knowledge graph tokens. For example, when a tabular model token and a knowledge graph token are located in a common row and a common column, the visibility level between the tabular model token and the knowledge graph token may be equal to 1. When the tabular model token and the knowledge graph token are located in a common row or a common column, but not both, the visibility level may be equal to 0.5. Some other value between 0 and 1 may alternatively be used to indicate partial visibility. When the tabular model token and the knowledge graph token have neither a row nor a column in common, the visibility level may be equal to 0. Using the visibility levels, attentional masking may be performed at the one or more knowledge fusion attention heads.

At step 220, the method 200 further includes generating the inferred table metadata based at least in part on the knowledge fusion attention output. The knowledge fusion attention output may be passed through additional layers of the metadata inference machine learning model when the inferred table metadata is generated.

FIG. 9C shows additional steps of the method 200 that may be performed in some examples. According to the example of FIG. 9C, the tabular model embedding sequence may be generated at step 212 as shown in FIG. 9B. At step 222, the method 200 further includes computing data category features and statistical distribution features from the plurality of entries. The data category features and the statistical distribution features may be included in a data category feature vector and a statistical distribution feature vector, respectively. The data category feature vector may indicate respective field categories associated with the tabular model tokens included in the tabular model embedding sequence. The statistical distribution feature vector may include a plurality of statistical quantities associated with the tabular model embedding sequence.

At step 224, the method 200 further includes computing a distribution fusion output based at least in part on the tabular model embedding sequence, the data category features, and the statistical distribution features. The distribution fusion output is computed at a distribution fusion module of the metadata inference machine learning model. In the distribution fusion output, tokens of a distribution fusion embedding sequence may be respectively paired with tokens of the statistical distribution feature vector.

At step 226, the method 200 further includes generating the inferred table metadata based at least in part on the distribution fusion output. In examples in which the steps of both FIG. 9B and FIG. 9C are performed, the inferred table metadata is generated using both the knowledge fusion attention output and the distribution fusion output.

In experiments performed by the inventors using the devices and methods discussed above, classification accuracy for row data and column data was increased for some classification tasks in comparison to previous table metadata inference techniques such as rule-based, GBDT, random forest, and TURL. The experiments used two different versions of the metadata inference machine learning model that respectively used TAPAS and TABBIE as the pre-trained tabular model. The metadata inference machine learning models and the previous metadata inference techniques were tested for classification tasks including dimension-versus-measure classification; natural key identification with a hit rate at 1; natural key identification with a hit rate at 3; group-by dimension identification with a hit rate at 1; group-by dimension identification with a hit rate at 3; common measure identification with a hit rate at 1; common measure identification with a hit rate at 3; dimension type identification; measure type identification; and measure pair identification. “Hit rate at k” refers to the rate at which the correct solution occurs in the top k highest-ranking results. The natural key identification tasks were tasks in which the metadata inference machine learning model predicted which column of the table was the most likely to be a key column. The common measure identification tasks were tasks in which the metadata inference machine learning model predicted the most probable measure variable types of respective columns.

Among the techniques tested in the experiment, the metadata inference machine learning models with TAPAS and TABBIE each had higher accuracy across all the tasks compared to the rule-based, GBDT, random forest, and TURL approaches. The metadata inference machine learning model with TAPAS achieved higher accuracy than the metadata inference machine learning model with TABBIE in dimension type identification and measure type identification, while the metadata inference machine learning model with TABBIE achieved higher accuracy in the other tasks.

The inventors also performed ablation studies in which the metadata inference machine learning models with TAPAS and TABBIE were both tested without distribution fusion, without knowledge fusion, and with neither distribution fusion nor knowledge fusion. In the ablation studies, the metadata inference machine learning model using TAPAS and the metadata inference machine learning model using TABBIE both achieved higher accuracy on the measure type identification task without distribution fusion. In addition, the metadata inference machine learning model using TABBIE also achieved higher accuracy on the dimension type identification task without distribution fusion. On the other tasks, the full metadata inference machine learning models achieved higher accuracy than the ablated metadata inference machine learning models.

In some embodiments, the methods and processes described herein may be tied to a computing system of one or more computing devices. In particular, such methods and processes may be implemented as a computer-application program or service, an application-programming interface (API), a library, and/or other computer-program product.

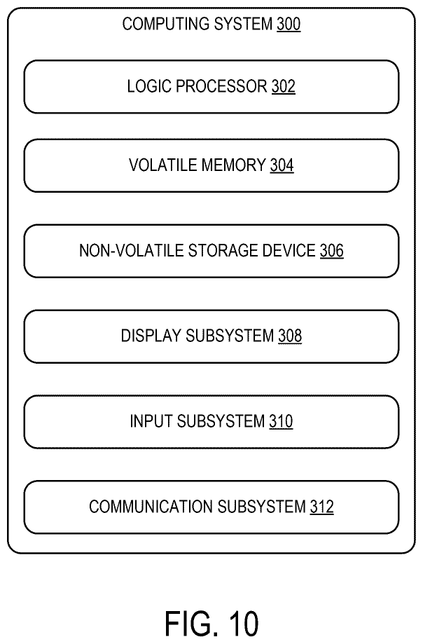

FIG. 10 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display subsystem 308, input subsystem 310, communication subsystem 312, and/or other components not shown in FIG. 10.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built-in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 300 to send and/or receive messages to and/or from other devices via a network such as the Internet.

The following paragraphs discuss several aspects of the present disclosure. According to one aspect of the present disclosure, a computing system is provided, including memory storing a table including a plurality of entries arranged in a plurality of rows and a plurality of columns. The memory further stores a knowledge graph in which semantic data is stored. The computing system further includes a processor that, at a metadata inference machine learning model, generates inferred table metadata based at least in part on the entries included in the table and the semantic data included in the knowledge graph. The inferred table metadata includes a row type classification of a respective row of the plurality of rows or a column type classification of a respective column of the plurality of columns. The processor further generates a metadata display interface element that visually represents the inferred table metadata. The processor further outputs the metadata display interface element for display at a graphical user interface (GUI). The above features may have the technical effect of utilizing the semantic data stored in the knowledge graph to present inferred table metadata that is more likely to be useful to the user.

According to this aspect, the metadata inference machine learning model may include a pre-trained tabular model at which the processor generates a tabular model embedding sequence based at least in part on the plurality of entries. The above features may have the technical effect of allowing the metadata inference machine learning model to be trained more quickly and with fewer computing resources.

According to this aspect, the processor may further compute a knowledge graph embedding sequence based at least in part on the semantic data included in the knowledge graph. At one or more knowledge fusion attention heads included in a knowledge fusion module of the metadata inference machine learning model, the processor may further compute a knowledge fusion attention output based at least in part on the tabular model embedding sequence and the knowledge graph embedding sequence. The processor may further generate the inferred table metadata based at least in part on the knowledge fusion attention output. The above features may have the technical effect of incorporating both the semantic data and the tabular model embedding sequence when computing the inferred table metadata.

According to this aspect, the processor may compute the knowledge fusion attention output at least in part by computing a plurality of visibility levels between a plurality of tabular model features included in the tabular model embedding sequence and a respective plurality of knowledge graph features included in the knowledge graph embedding sequence. The plurality of visibility levels may indicate coordinate overlap levels between the tabular model features and the knowledge graph features. The above features may have the technical effect of performing relevance-based attentional masking between the tabular model features and the knowledge graph features.

According to this aspect, the processor may further compute data category features and statistical distribution features from the plurality of entries. At a distribution fusion module of the metadata inference machine learning model, the processor may further compute a distribution fusion output based at least in part on the tabular model embedding sequence, the data category features, and the statistical distribution features. The processor may generate the inferred table metadata based at least in part on the distribution fusion output. The above features may have the technical effect of utilizing distribution data to generate inferred table metadata that is more likely to be useful to the user.

According to this aspect, the metadata inference machine learning model may include a cell-level encoder and a column-level encoder. The above features may have the technical effect of encoding cell-level and column-level features of the data stored in the table when computing the inferred table metadata.

According to this aspect, the row type classification may include a respective indication of whether the row includes values of a dimension variable or a measure variable, or the column type classification may include a respective indication of whether the column includes values of a dimension variable or a measure variable. The above features may have the technical effect of identifying a property of a row or column that is likely to inform further analysis of the data stored in the table.

According to this aspect, the inferred table metadata may include an indication of a key row of the plurality of rows or a key column of the plurality of columns. The inferred table metadata may further include an indication of a group-by dimension. The metadata display interface element may depict the entries included in the key row or the key column grouped according to the group-by dimension. The above features may have the technical effect of organizing the data included in the metadata display interface element in a manner that is likely to reflect properties of the data that are relevant to the user.

According to this aspect, the inferred table metadata may further include a dimension variable type of a dimension variable or a measure variable type of a measure variable. The above features may have the technical effect of inferring metadata that informs the generation of the metadata display interface element such that the metadata display interface element is likely to be relevant to the user.

According to this aspect, the inferred table metadata may further include a measure pair indicator associated with a first measure variable and a second measure variable. The above features may have the technical effect of organizing the data included in the metadata display interface element in a manner that is likely to reflect properties of the data that are relevant to the user.

According to this aspect, the inferred table metadata may further include a default aggregation function associated with a measure variable. The above features may have the technical effect of inferring metadata that informs the generation of the metadata display interface element such that the metadata display interface element is likely to be relevant to the user.

According to this aspect, the knowledge graph may include a plurality of entities and a plurality of directed edges indicating relationships between the entities. The above features may have the technical effect of encoding semantic relationships between the entities included in the knowledge graph.

According to another aspect of the present disclosure, a method for use with a computing system is provided. The method includes storing, in memory, a table including a plurality of entries arranged in a plurality of rows and a plurality of columns. The method further includes storing, in the memory, a knowledge graph including semantic data. The method further includes, at a metadata inference machine learning model, generating inferred table metadata based at least in part on the entries included in the table and the semantic data included in the knowledge graph. The inferred table metadata includes a row type classification of a respective row of the plurality of rows or a column type classification of a respective column of the plurality of columns. The method further includes generating a metadata display interface element that visually represents the inferred table metadata. The method further includes outputting the metadata display interface element for display at a graphical user interface (GUI). The above features may have the technical effect of utilizing the semantic data stored in the knowledge graph to present inferred table metadata that is more likely to be useful to the user.

According to this aspect, the method may further include, at a pre-trained tabular model included in the metadata inference machine learning model, generating a tabular model embedding sequence based at least in part on the plurality of entries. The above features may have the technical effect of allowing the metadata inference machine learning model to be trained more quickly and with fewer computing resources.

According to this aspect, the method may further include computing a knowledge graph embedding sequence based at least in part on the semantic data included in the knowledge graph. The method may further include, at one or more knowledge fusion attention heads included in a knowledge fusion module of the metadata inference machine learning model, computing a knowledge fusion attention output based at least in part on the tabular model embedding sequence and the knowledge graph embedding sequence. The method may further include generating the inferred table metadata based at least in part on the knowledge fusion attention output. The above features may have the technical effect of incorporating both the semantic data and the tabular model embedding sequence when computing the inferred table metadata.

According to this aspect, the method may further include computing data category features and statistical distribution features from the plurality of entries. At a distribution fusion module of the metadata inference machine learning model, the method may further include computing a distribution fusion output based at least in part on the tabular model embedding sequence, the data category features, and the statistical distribution features. The method may further include generating the inferred table metadata based at least in part on the distribution fusion output. The above features may have the technical effect of utilizing distribution data to generate inferred table metadata that is more likely to be useful to the user.

According to this aspect, the row type classification may include a respective indication of whether the row includes values of a dimension variable or a measure variable, or the column type classification may include a respective indication of whether the column includes values of a dimension variable or a measure variable. The above features may have the technical effect of identifying a property of a row or column that is likely to inform further analysis of the data stored in the table.

According to this aspect, the inferred table metadata may include an indication of a key row of the plurality of rows or a key column of the plurality of columns. The inferred table metadata may further include an indication of a group-by dimension. The metadata display interface element may depict the entries included in the key row or the key column grouped according to the group-by dimension. The above features may have the technical effect of organizing the data included in the metadata display interface element in a manner that is likely to reflect properties of the data that are relevant to the user.

According to this aspect, the inferred table metadata may further include a dimension variable type of a dimension variable, a measure variable type of a measure variable, a measure pair indicator associated with a first measure variable and a second measure variable, or a default aggregation function associated with a measure variable. The above features may have the technical effect of inferring metadata that informs the generation of the metadata display interface element such that the metadata display interface element is likely to be relevant to the user.

According to another aspect of the present disclosure, a computing system is provided, including a processor that receives a table including a plurality of entries arranged in a plurality of rows and a plurality of columns. At a metadata inference machine learning model, the processor generates inferred table metadata at least in part by, at a pre-trained tabular model, generating a tabular model embedding sequence based at least in part on the plurality of entries. Generating the inferred table metadata further includes computing a knowledge graph embedding sequence based at least in part on the semantic data included in a knowledge graph. Generating the inferred table metadata further includes computing a knowledge fusion attention output based at least in part on the tabular model embedding sequence and the knowledge graph embedding sequence. Generating the inferred table metadata further includes computing data category features and statistical distribution features from the plurality of entries. Generating the inferred table metadata further includes computing a distribution fusion output based at least in part on the tabular model embedding sequence, the data category features, and the statistical distribution features. The inferred table metadata is generated based at least in part on the knowledge fusion attention output and the distribution fusion output. The processor further outputs the inferred table metadata for display at a display device. The above features may have the technical effect of utilizing semantic data and distribution data to present inferred table metadata that is more likely to be useful to the user.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
memory storing:
a table including a plurality of entries arranged in a plurality of rows and a plurality of columns; and
a knowledge graph in which semantic data is stored; and
a processor that:
at a metadata inference machine learning model, generates inferred table metadata based at least in part on the entries included in the table and the semantic data included in the knowledge graph, wherein the inferred table metadata includes:
a row type classification of a respective row of the plurality of rows; or
a column type classification of a respective column of the plurality of columns;
generates a metadata display interface element that visually represents the inferred table metadata; and
outputs the metadata display interface element for display at a graphical user interface (GUI).

2. The computing system of claim 1, wherein the metadata inference machine learning model includes a pre-trained tabular model at which the processor generates a tabular model embedding sequence based at least in part on the plurality of entries.

3. The computing system of claim 2, wherein the processor further:
computes a knowledge graph embedding sequence based at least in part on the semantic data included in the knowledge graph;
at one or more knowledge fusion attention heads included in a knowledge fusion module of the metadata inference machine learning model, computes a knowledge fusion attention output based at least in part on the tabular model embedding sequence and the knowledge graph embedding sequence; and
generates the inferred table metadata based at least in part on the knowledge fusion attention output.

4. The computing system of claim 3, wherein:
the processor computes the knowledge fusion attention output at least in part by computing a plurality of visibility levels between a plurality of tabular model features included in the tabular model embedding sequence and a respective plurality of knowledge graph features included in the knowledge graph embedding sequence; and
the plurality of visibility levels indicate coordinate overlap levels between the tabular model features and the knowledge graph features.

5. The computing system of claim 2, wherein the processor further:
computes data category features and statistical distribution features from the plurality of entries;
at a distribution fusion module of the metadata inference machine learning model, computes a distribution fusion output based at least in part on the tabular model embedding sequence, the data category features, and the statistical distribution features; and
generates the inferred table metadata based at least in part on the distribution fusion output.

6. The computing system of claim 1, wherein the metadata inference machine learning model includes a cell-level encoder and a column-level encoder.

7. The computing system of claim 1, wherein:
the row type classification includes a respective indication of whether the row includes values of a dimension variable or a measure variable; or
the column type classification includes a respective indication of whether the column includes values of a dimension variable or a measure variable.

8. The computing system of claim 7, wherein:
the inferred table metadata includes:
an indication of a key row of the plurality of rows or a key column of the plurality of columns; and
an indication of a group-by dimension; and
the metadata display interface element depicts the entries included in the key row or the key column grouped according to the group-by dimension.

9. The computing system of claim 7, wherein the inferred table metadata further includes a dimension variable type of a dimension variable or a measure variable type of a measure variable.

10. The computing system of claim 7, wherein the inferred table metadata further includes a measure pair indicator associated with a first measure variable and a second measure variable.

11. The computing system of claim 7, wherein the inferred table metadata further includes a default aggregation function associated with a measure variable.

12. The computing system of claim 1, wherein the knowledge graph includes:
a plurality of entities; and
a plurality of directed edges indicating relationships between the entities.

13. A method for use with a computing system, the method comprising:
storing, in memory, a table including a plurality of entries arranged in a plurality of rows and a plurality of columns;
storing, in the memory, a knowledge graph including semantic data;
at a metadata inference machine learning model, generating inferred table metadata based at least in part on the entries included in the table and the semantic data included in the knowledge graph, wherein the inferred table metadata includes:
a row type classification of a respective row of the plurality of rows; or
a column type classification of a respective column of the plurality of columns;
generating a metadata display interface element that visually represents the inferred table metadata; and
outputting the metadata display interface element for display at a graphical user interface (GUI).

14. The method of claim 13, further comprising, at a pre-trained tabular model included in the metadata inference machine learning model, generating a tabular model embedding sequence based at least in part on the plurality of entries.

15. The method of claim 14, further comprising:
computing a knowledge graph embedding sequence based at least in part on the semantic data included in the knowledge graph;
at one or more knowledge fusion attention heads included in a knowledge fusion module of the metadata inference machine learning model, computing a knowledge fusion attention output based at least in part on the tabular model embedding sequence and the knowledge graph embedding sequence; and
generating the inferred table metadata based at least in part on the knowledge fusion attention output.

16. The method of claim 14, further comprising:
computing data category features and statistical distribution features from the plurality of entries;
at a distribution fusion module of the metadata inference machine learning model, computing a distribution fusion output based at least in part on the tabular model embedding sequence, the data category features, and the statistical distribution features; and
generating the inferred table metadata based at least in part on the distribution fusion output.

17. The method of claim 13, wherein:
the row type classification includes a respective indication of whether the row includes values of a dimension variable or a measure variable; or
the column type classification includes a respective indication of whether the column includes values of a dimension variable or a measure variable.

18. The method of claim 17, wherein:
the inferred table metadata includes:
an indication of a key row of the plurality of rows or a key column of the plurality of columns; and
an indication of a group-by dimension; and
the metadata display interface element depicts the entries included in the key row or the key column grouped according to the group-by dimension.

19. The method of claim 17, wherein the inferred table metadata further includes:
a dimension variable type of a dimension variable;
a measure variable type of a measure variable;
a measure pair indicator associated with a first measure variable and a second measure variable; or
a default aggregation function associated with a measure variable.

20. A computing system comprising:
a processor that:
receives a table including a plurality of entries arranged in a plurality of rows and a plurality of columns;
at a metadata inference machine learning model, generates inferred table metadata at least in part by:
at a pre-trained tabular model, generating a tabular model embedding sequence based at least in part on the plurality of entries;
computing a knowledge graph embedding sequence based at least in part on the semantic data included in a knowledge graph;
computing a knowledge fusion attention output based at least in part on the tabular model embedding sequence and the knowledge graph embedding sequence;
computing data category features and statistical distribution features from the plurality of entries;
computing a distribution fusion output based at least in part on the tabular model embedding sequence, the data category features, and the statistical distribution features; and
generating the inferred table metadata based at least in part on the knowledge fusion attention output and the distribution fusion output; and
outputs the inferred table metadata for display at a display device.
